(19) United States
(12) Patent Application Publication
(10) Pub. No.: US 2025/0073730 A1
(43) Pub. Date: Mar. 6, 2025

(54) SPRAY GENERATION APPARATUS

(71) Applicant: Greenworks (Jiangsu) Co., Ltd, Changzhou (CN)

(72) Inventors: Kaihong Tang, Changzhou (CN); Guangda Zhao, Changzhou (CN)

(21) Appl. No.: 18/820,367

(22) Filed: Aug. 30, 2024

(30) Foreign Application Priority Data
Aug. 30, 2023 (CN) 202322354646.7

(51) Int. Cl. B05B 12/00; B05B 1/12

(52) U.S. Cl. CPC B05B 12/002; B05B 1/12

(57) ABSTRACT

A spray generation apparatus includes a housing, knob, a resistor device, a motor and a motor controller. The knob includes an open bottom and a connector extending in a direction of the open bottom. The housing includes an aperture for the connector to pass through. The housing includes a first detent position and a second detent position. The knob is capable of being rotated to the first detent position or the second detent position. The resistor device is disposed inside the housing. The connector is attached to the resistor device. The motor controller controls the motor to generate a first spray with a first spray output pattern when the resistor device generates a first voltage value and the knob is at the first detent position.

### CROSS REFERENCE TO RELATED APPLICATIONS

The present application claims the benefit of Chinese Patent Application No. 2023223546467 filed on Aug. 30, 2023, the contents of which are incorporated herein by reference in their entirety.

### FIELD

The present invention is related to a spray generation apparatus, and more particularly related to a spray generation apparatus with a flexible control.

### BACKGROUND

A spray machine equipped with a motor can be highly versatile, serving a wide range of applications across different fields. In agricultural settings, it can be used to spray pesticides, ensuring crops are protected from harmful insects and diseases. By precisely distributing the pesticide over large areas, the machine helps maintain the health and yield of various crops, contributing to more efficient farming practices.

In addition to its agricultural uses, the spray machine is also valuable for maintaining the health of delicate plants, such as orchids. The machine can be adjusted to deliver a fine mist of water, providing the gentle hydration these plants require without damaging their fragile leaves or flowers. This ability to control the spray intensity makes it an essential tool for horticulturists and gardeners who need to care for sensitive plant species.

Beyond agriculture and horticulture, the spray machine is instrumental in controlling the environment in various settings. For instance, it can be used to cool down an outdoor area during hot weather. By spraying a fine mist of water, the machine helps lower the ambient temperature, making outdoor spaces more comfortable for people to enjoy.

The machine is also effective in disinfection tasks, where it can be used to spray disinfectant solutions over surfaces in public spaces, hospitals, or even homes. This capability is particularly important in ensuring hygiene and reducing the spread of pathogens in areas that require high standards of cleanliness.

In industrial applications, the spray machine can be used to apply coatings to surfaces, such as in painting or sealing operations. The motor-driven spray ensures a consistent and even application, which is crucial for achieving high-quality finishes in manufacturing processes.

Another practical use of the spray machine is in pest control, where it can be employed to distribute insecticides in areas prone to infestations. This method is particularly effective in covering large areas quickly, ensuring that pests are eradicated efficiently and with minimal human intervention.

In addition to its pest control capabilities, the machine can also be utilized in the maintenance of outdoor spaces, such as golf courses or public parks. It can be used to evenly distribute fertilizers or herbicides, helping to keep the grass and plants healthy and free from unwanted weeds.

The spray machine's utility extends to environmental protection efforts as well. It can be employed to apply bio-remediation agents to contaminated soils or water bodies, aiding in the clean-up of pollutants and contributing to the restoration of natural ecosystems.

In firefighting, the spray machine can be adapted to disperse water or fire retardants over burning areas, providing a means to control or extinguish fires in outdoor environments. The motor-driven spray ensures that large areas can be covered quickly, which is crucial in emergency situations.

Finally, the spray machine can be used in artistic or creative endeavors, such as in the creation of large-scale murals or outdoor art installations. The machine allows for the application of paints or other materials with precision, enabling artists to achieve their desired effects over expansive surfaces.

When used in gardening or related operations, the convenience of the spray machine is paramount. Gardeners often need to maneuver around different areas, reaching various plants that may be spread across a wide or complex layout. A spray machine that is lightweight, easy to carry, and simple to operate can significantly reduce the physical strain on the user, making the task of watering, fertilizing, or applying pesticides much more manageable. Features such as adjustable nozzles, ergonomic handles, and easy-to-use controls enhance the user experience, allowing for precise application without the hassle.

Cost is another critical factor that cannot be overlooked. While the functionality and efficiency of the spray machine are essential, the overall cost of ownership, including initial purchase, maintenance, and operational expenses, must be carefully considered. Gardeners, whether professionals or hobbyists, often work within a budget, so finding a spray machine that offers a good balance between quality and affordability is key. Durable materials that require less frequent replacement, energy-efficient motors that reduce power consumption, and designs that minimize the use of consumables like pesticides or water can all contribute to cost savings over time.

Innovative designs that incorporate flexible control options are increasingly important in modern gardening. A spray machine with variable settings for pressure, spray patterns, and coverage areas allows the user to adapt to different tasks with ease. Whether it's a delicate mist for seedlings, a broader spray for mature plants, or a targeted stream for applying nutrients, the ability to switch between modes without needing multiple tools enhances both the versatility and efficiency of the gardening operation. Such flexibility not only improves the outcomes of the tasks at hand but also makes the machine a more valuable and long-lasting investment.

Function variety in a spray machine can greatly extend its usefulness across different gardening tasks. A machine that can handle multiple functions-such as watering, fertilizing, pest control, and even misting for humidity control in greenhouses-provides greater value to the user. This multi-functionality eliminates the need for multiple devices, saving space and reducing the complexity of garden maintenance. It also ensures that the gardener has a comprehensive tool that can be relied upon for various needs throughout the growing season.

As the demand for more efficient and effective gardening tools grows, there is a continuous need to innovate and improve spray machine designs. Manufacturers must consider not only the current needs of gardeners but also anticipate future trends and challenges. This might involve integrating smart technology for automated or remote-controlled spraying, developing eco-friendly options that reduce water and chemical usage, or creating modular systems that can be customized based on specific garden layouts or plant types. By focusing on these aspects, new spray machines can offer enhanced performance, greater convenience, and better cost-efficiency, meeting the evolving needs of the gardening community.

### SUMMARY

In some embodiments, a spray generation apparatus includes a housing, knob, a resistor device, a motor and a motor controller.

The knob includes an open bottom and a connector extending in a direction of the open bottom.

The housing includes an aperture for the connector to pass through.

The connector is rotatably connected to the housing after passing through the aperture so that the knob is capable of rotating relative to the housing.

The housing includes a first detent position and a second detent position.

The knob is capable of being rotated to the first detent position or the second detent position.

The resistor device is disposed inside the housing.

The connector is attached to the resistor device.

The motor controller controls the motor to generate a first spray with a first spray output pattern when the resistor device generates a first voltage value and the knob is at the first detent position. The motor controller controls the motor to generate a second spray with a second spray output pattern when the resistor device generates a second voltage value and the knob is at the second detent position.

In some embodiments, the housing includes a positioning seat surrounding the aperture, the positioning seat being provided with at least a first toothed groove and a second toothed groove.

The knob further includes a protruding portion extending from a side of the connector in the direction of the open bottom.

The knob is in the first detent position when the protruding portion is confined within the first toothed groove, and the knob is in the second detent position when the protruding portion is confined within the second toothed groove.

In some embodiments, the first toothed groove and the second toothed groove are adjacent to each other, such that the outer edge of the positioning seat has a wavy shape.

In some embodiments, the control assembly further includes an elastic member fixedly connected to the knob.

The elastic member is sleeved on the connector.

The protruding portion is disposed on the elastic member and extends over the outside of the connector.

The protruding portion is compressed to deform the elastic member when the knob switches between the first detent position and the second detent position.

In some embodiments, the bottom inner wall of the knob is provided with an isolation post protruding toward the connector.

The housing further includes a first limiting part and a second limiting part extending outwardly from the positioning seat, the first limiting part and the second limiting part extending in different directions to form a limiting region between them.

When the knob is connected to the housing, the isolation post is located within the limiting region.

When the knob is rotated, the isolation post slides along the limiting region.

In some embodiments, the limiting region is a sector-shaped area of 200°.

The knob is capable of rotating between 0° and 200°.

In some embodiments, the first toothed groove and the second toothed groove are respectively located at opposite ends of the limiting region.

In some embodiments, the end of the connector is provided with an elastically extending locking arm and a locking hook protruding outwardly from the locking arm.

The housing is provided with a coupling portion surrounding the aperture.

When the knob is connected to the housing, the locking hook engages with the coupling portion.

In some embodiments, the resistor device is provided with a positioning portion and a positioning member fixedly connected to the positioning portion.

The positioning portion is fixedly connected to the housing, and the positioning member is provided with a positioning surface.

A corresponding mating surface is provided on the inner side wall of the connector.

When the connector passes through the aperture and is fixedly connected to the resistor device, the positioning surface and the mating surface abut against each other, thereby fixing the resistor device to the connector.

In some embodiments, the spray generation apparatus may also include a liquid tank.

The motor is controlled by the motor controller to generate the first spray with liquid stored in the liquid tank at a first pressure and flow rate.

The motor is controlled by the motor controller to generate the second spray with liquid stored in the liquid tank.

In some embodiments, the spray generation apparatus may also include a battery container disposed in the housing.

A power switch is provided on the housing to turn on power.

In some embodiments, the spray generation apparatus may also include a second housing for disposing the motor and the liquid tank.

The second housing is separate from the housing.

In some embodiments, the spray generation apparatus may also include a bracket for placing the housing and the second housing.

In some embodiments, different output patterns correspond to different watering patterns for gardening.

In some embodiments, the liquid tank contains a pesticide mixer for mixing a pesticide with water for a required pesticide concentration.

In some embodiments, the spray generation apparatus may also include a movement device fixed to the housing.

The movement device automatically navigates an area for performing spray operation.

In some embodiments, the spray generation apparatus may also include a sensor to detect a liquid level in the liquid tank.

When the liquid level is below a threshold, a vibration message is generated to inform the user to refill the liquid tank.

In some embodiments, the spray generation apparatus may also include a lock on the housing.

When the lock is positioned at a lock position, the motor is disabled to prevent spraying danger spray in accident.

In some embodiments, a spray pipe is detachably attached to the housing.

The s pray pipe is connected to spray exit of the housing.

In some embodiments, a second knob is disposed on a distal end of the spray pipe away from the housing.

The second knob is operable to perform the same function as the knob to the motor controller.

### BRIEF DESCRIPTION OF DRAWINGS

FIG. 1 illustrates a top view for the knob and the housing.

FIG. 2 illustrates a bottom view for the knob and a portion of the housing.

FIG. 3 illustrates a diagram showing the structure of detent positions on the housing.

FIG. 4 illustrates a zoom-up view of the detention position structures.

FIG. 5 illustrates a component for detecting the knob operation.

FIG. 6 illustrates a inner structure for fixing the knob connector.

FIG. 7 illustrates a knob structure.

FIG. 8 illustrates another component example.

FIG. 9 illustrates a resistor device example.

FIG. 10 illustrates a spray generation apparatus embodiment.

FIG. 11 illustrates another spray generation apparatus embodiment.

### DETAILED DESCRIPTION

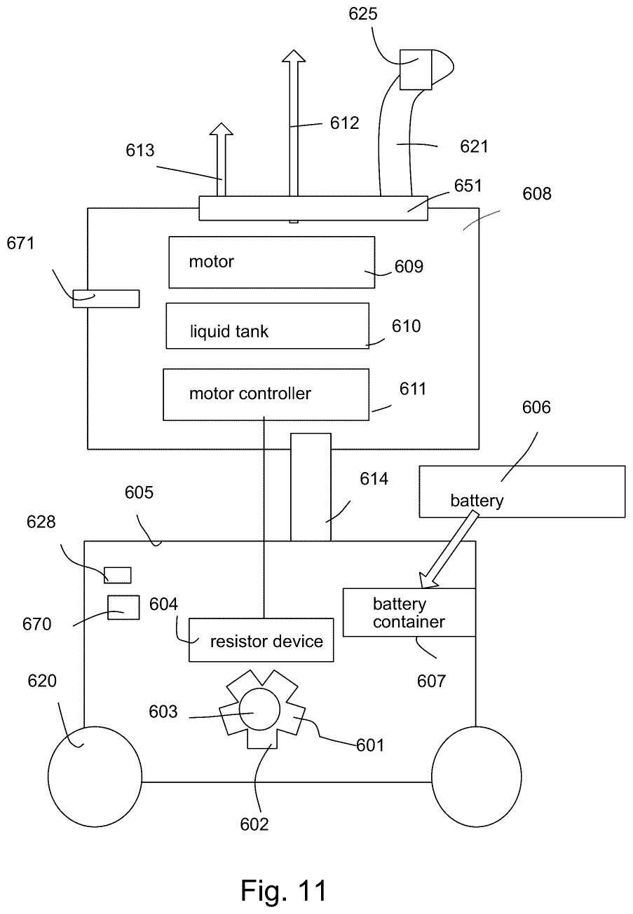

In FIG. 11, a spray generation apparatus includes a housing 605, knob 603, a resistor device 604, a motor 609 and a motor controller 611.

The knob 603 includes an open bottom and a connector extending in a direction of the open bottom.

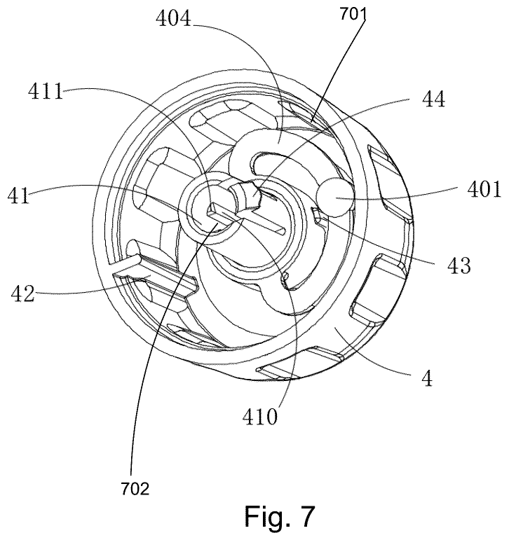

FIG. 7 shows an example of the knob that has an open bottom 701 and a connector 702.

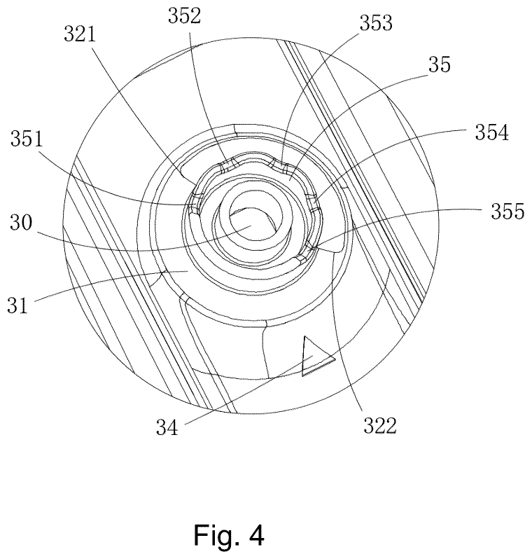

The housing includes an aperture for the connector to pass through. FIG. 4 shows such an aperture. More details will be described in following examples.

The connector is rotatably connected to the housing after passing through the aperture so that the knob is capable of rotating relative to the housing.

The housing includes a first detent position and a second detent position.

FIG. 4 show several detent structures are used for defining corresponding detent positions.

The knob is capable of being rotated to the first detent position or the second detent position.

The resistor device 604 is disposed inside the housing 605.

The connector is attached to the resistor device 605.

The motor controller 611 controls the motor 609 to generate a first spray 613 with a first spray output pattern when the resistor device 604 generates a first voltage value and the knob 603 is at the first detent position 601. The motor controller controls the motor to generate a second spray 612 with a second spray output pattern when the resistor device 604 generates a second voltage value and the knob 603 is at the second detent position 602.

In some embodiments, the housing includes a positioning seat surrounding the aperture, the positioning seat being provided with at least a first toothed groove and a second toothed groove.

The knob further includes a protruding portion extending from a side of the connector in the direction of the open bottom.

The knob is in the first detent position when the protruding portion is confined within the first toothed groove, and the knob is in the second detent position when the protruding portion is confined within the second toothed groove.

In some embodiments, the first toothed groove and the second toothed groove are adjacent to each other, such that the outer edge of the positioning seat has a wavy shape.

In some embodiments, the control assembly further includes an elastic member fixedly connected to the knob.

The elastic member is sleeved on the connector.

The protruding portion is disposed on the elastic member and extends over the outside of the connector.

The protruding portion is compressed to deform the elastic member when the knob switches between the first detent position and the second detent position.

In some embodiments, the bottom inner wall of the knob is provided with an isolation post protruding toward the connector.

The housing further includes a first limiting part and a second limiting part extending outwardly from the positioning seat, the first limiting part and the second limiting part extending in different directions to form a limiting region between them.

When the knob is connected to the housing, the isolation post is located within the limiting region.

When the knob is rotated, the isolation post slides along the limiting region.

In some embodiments, the limiting region is a sector-shaped area of 200°.

The knob is capable of rotating between 0° and 200°.

In some embodiments, the first toothed groove and the second toothed groove are respectively located at opposite ends of the limiting region.

In some embodiments, the end of the connector is provided with an elastically extending locking arm and a locking hook protruding outwardly from the locking arm.

The housing is provided with a coupling portion surrounding the aperture.

When the knob is connected to the housing, the locking hook engages with the coupling portion.

In some embodiments, the resistor device is provided with a positioning portion and a positioning member fixedly connected to the positioning portion.

The positioning portion is fixedly connected to the housing, and the positioning member is provided with a positioning surface.

A corresponding mating surface is provided on the inner side wall of the connector.

When the connector passes through the aperture and is fixedly connected to the resistor device, the positioning surface and the mating surface abut against each other, thereby fixing the resistor device to the connector.

In FIG. 11, the spray generation apparatus may also include a liquid tank 610.

The motor 609 is controlled by the motor controller 611 to generate the first spray 613 with liquid stored in the liquid tank 610 at a first pressure and flow rate.

The motor 609 is controlled by the motor controller 611 to generate the second spray 612 with liquid stored in the liquid tank 610.

In some embodiments, the spray generation apparatus may also include a battery container 607 disposed in the housing 605 for containing a detachable battery.

A power switch 670 is provided on the housing 605 to turn on power.

In some embodiments, the spray generation apparatus may also include a second housing 608 for disposing the motor 609 and the liquid tank 610.

The second housing 608 is separate from the housing 605.

In some embodiments, the spray generation apparatus may also include a bracket 614 for placing the housing 605 and the second housing 608.

In some embodiments, different output patterns correspond to different watering patterns for gardening.

In some embodiments, the liquid tank 610 contains a pesticide mixer for mixing a pesticide with water for a required pesticide concentration.

In some embodiments, the spray generation apparatus may also include a movement device 620 fixed to the housing 605.

The movement device 620 automatically navigate an area for performing spray operation.

In one embodiment of the spray generation apparatus, the system is further enhanced with automatic navigation capabilities, allowing it to autonomously traverse an area and perform spraying operations. This automation is particularly beneficial in large agricultural fields, greenhouses, or expansive gardens where manual spraying would be time-consuming and labor-intensive. The apparatus is equipped with a navigation module that includes sensors, GPS technology, and path planning algorithms, enabling it to map out the area and determine the most efficient spraying route. This ensures comprehensive coverage of the target area while minimizing overlap and reducing the time required to complete the spraying task.

The integration of the automatic navigation system with the spray generation apparatus allows for real-time adjustments to spraying parameters based on the specific conditions of the environment. For instance, as the apparatus moves through the area, it can detect variations in terrain, plant density, or obstacles. The control system can then automatically adjust the spray pressure, flow rate, or pattern to optimize the application of the liquid, whether it be pesticides, fertilizers, or water. This adaptability not only improves the effectiveness of the spraying operation but also conserves resources by preventing excessive use of the liquid being sprayed.

Safety is a critical aspect of the automatically navigating spray generation apparatus. The system is designed to include obstacle detection and avoidance features, which prevent the apparatus from colliding with structures, plants, or other objects in its path. Sensors continuously monitor the surroundings, and if an obstacle is detected, the apparatus can either stop, reroute, or adjust its spraying mechanism to avoid the obstacle while continuing to operate. This ensures that the apparatus can safely navigate complex environments, such as densely planted areas or fields with uneven terrain.

Another significant advantage of the automatic navigation feature is its ability to operate under various environmental conditions. The apparatus can be programmed to spray at specific times of the day, such as early morning or late afternoon, when environmental factors like wind and temperature are optimal for spraying. This scheduling flexibility ensures that the spraying operation is both efficient and effective, reducing the risk of drift and evaporation that can occur under less favorable conditions. Moreover, the apparatus can be equipped with weather sensors that allow it to adapt its operation in real-time, pausing spraying during rain or strong winds and resuming once conditions are suitable.

Overall, the embodiment of the spray generation apparatus with automatic navigation represents a significant advancement in agricultural and horticultural practices. By combining precise control over spraying parameters with autonomous operation, the system enhances productivity, reduces labor costs, and ensures consistent application of sprays across large or complex areas. This innovation not only addresses the challenges of modern agriculture but also contributes to more sustainable practices by optimizing the use of resources and minimizing environmental impact.

Automatic navigation is particularly beneficial when using sprays that may be harmful to human health, as it minimizes direct human exposure to potentially hazardous chemicals. In gardening and agriculture, certain pesticides, herbicides, and fungicides are essential for protecting plants from pests, diseases, and weeds. However, these chemicals can pose risks to humans if inhaled, ingested, or absorbed through the skin. By employing an automatically navigating spray generation apparatus, the need for human operators to be physically present during the spraying process is eliminated, thereby reducing the likelihood of exposure to these harmful substances.

One common example of a spray used in gardening that can be harmful to humans is glyphosate, a widely used herbicide for controlling weeds. Although effective, glyphosate has been linked to health concerns, including respiratory issues and potential carcinogenic effects when individuals are exposed to it over time. An automatic navigation system allows the spray generation apparatus to apply glyphosate precisely and efficiently across large areas without requiring human intervention, ensuring that the chemical is used effectively while keeping people at a safe distance.

Similarly, insecticides containing organophosphates, such as malathion, are commonly used in gardening to combat insect infestations. While effective against pests, organophosphates can be toxic to humans, causing symptoms like headaches, dizziness, and nausea upon exposure. An automatic navigation system can safely operate the spray generation apparatus to distribute insecticides in targeted areas, such as flower beds or vegetable gardens, without the need for human operators to handle or be near the chemicals during application, thereby reducing the risk of accidental poisoning.

Fungicides, such as those containing chlorothalonil, are often used to protect plants from fungal diseases. While they play a crucial role in maintaining plant health, these chemicals can irritate the skin and eyes and may have longer-term health effects with repeated exposure. The use of an automatically navigating spray generation apparatus ensures that fungicides are applied only where needed, with precise control over the amount and distribution of the spray, thus minimizing the risk of human contact with these potentially harmful substances.

In addition to protecting human health, automatic navigation also enhances the overall safety of the spraying operation. By reducing the need for manual handling of toxic chemicals, the system decreases the chances of accidental spills, over-application, and other mistakes that could lead to dangerous exposure. This makes automatic navigation an invaluable feature for gardeners, farmers, and landscapers who regularly work with hazardous sprays, allowing them to maintain their plants effectively while safeguarding their own health and well-being.

In some embodiments, the spray generation apparatus may also include a sensor 671 to detect a liquid level in the liquid tank 610.

When the liquid level is below a threshold, a vibration message is generated to inform the user to refill the liquid tank 610. This is helpful because when user is operating the device in a farm or garden, the user may focus on watching the plants.

In some embodiments, the spray generation apparatus may also include a lock 628 on the housing 605.

When the lock 605 is positioned at a lock position, the motor is disabled to prevent spraying danger spray in accident.

In some embodiments, a spray pipe 621 is detachably attached to the housing 503.

The spray pipe 621 is connected to spray exit 651 of the housing.

In some embodiments, a second knob 625 is disposed on a distal end of the spray pipe 621 away from the housing.

The second knob 625 is operable to perform the same function as the knob 603 to the motor controller 611.

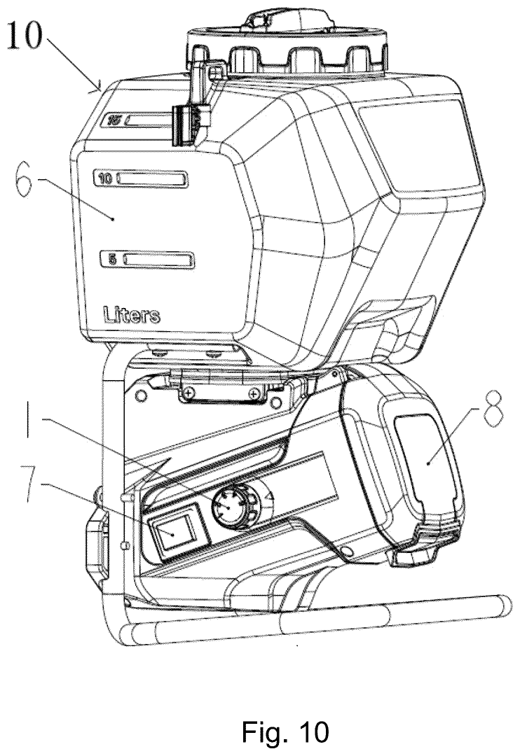

Referring to FIG. 10, the present application discloses a spray generation apparatus 10, comprising a liquid tank 6, a power switch 7, a battery compartment 8, and a knob assembly 1. When a battery is inserted into the battery compartment 8 and the power switch 7 is closed, rotating the knob assembly 1 enables the control board inside the spray generation apparatus 10 to change the rotational speed of the water pump motor inside the spray generation apparatus 10, thereby adjusting the pressure and flow rate of the liquid being sprayed. Since the specific structures of the liquid tank 6, the power switch 7, and the battery compartment 8 can all adopt existing technical solutions, the specific structures of the liquid tank 6, the power switch 7, and the battery compartment 8 are not described here.

The knob assembly 1 is suitable for use in various fields, such as the cleaning tools industry, and is particularly applicable to the field of sprayers. The following description details the specific structure and working principle of the knob assembly 1 in conjunction with the spray generation apparatus 10.

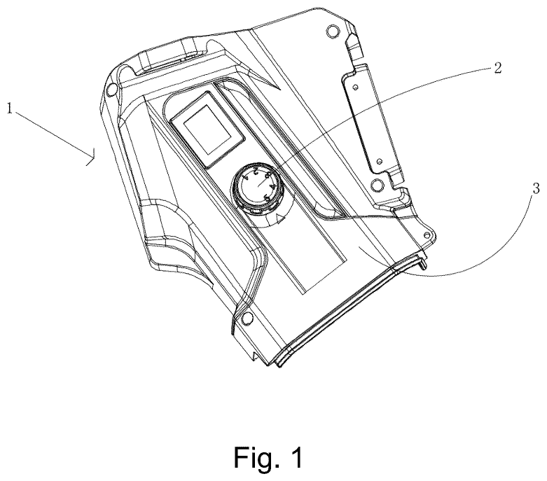

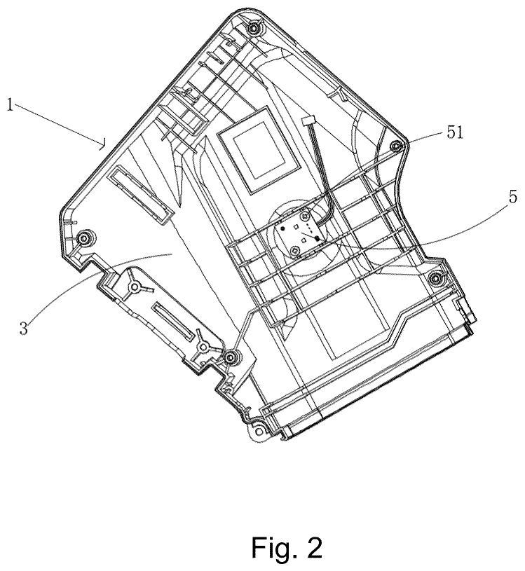

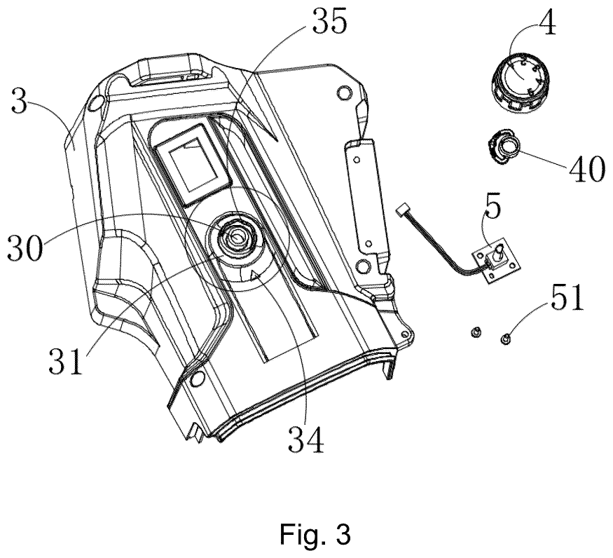

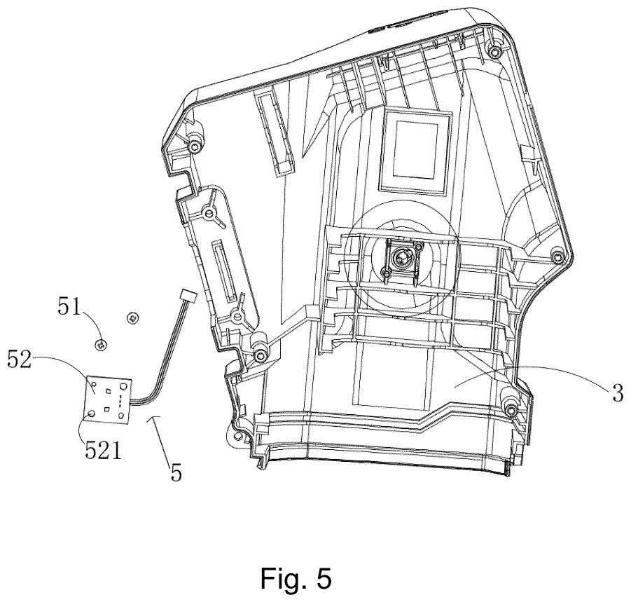

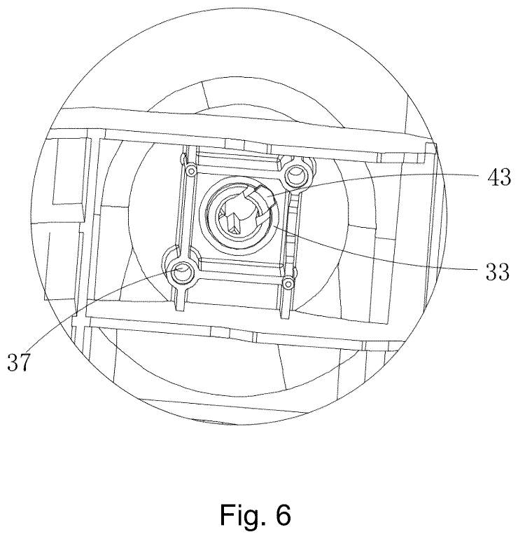

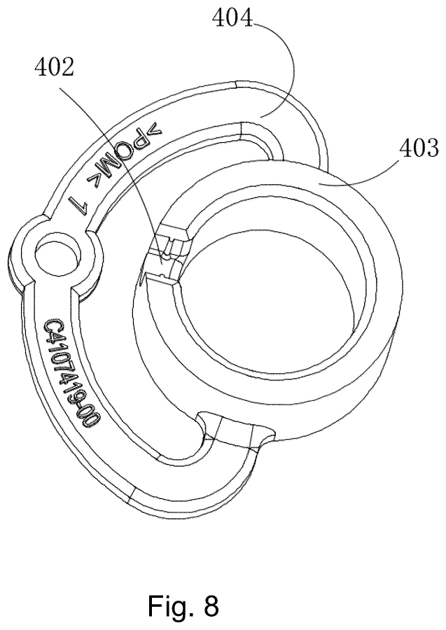

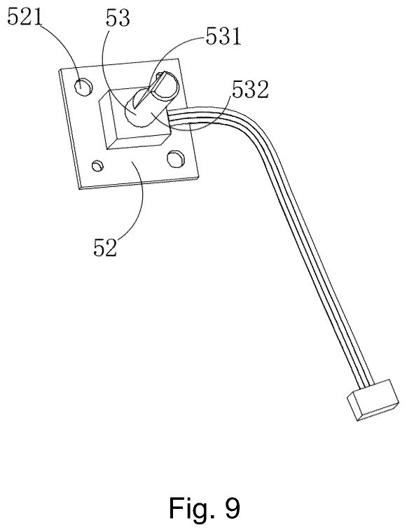

Referring to FIGS. 1 to 9, the knob assembly 1 includes a housing 3 and a control assembly 2 fixed to the exterior of the housing 3. The control assembly 2 comprises a knob 4 and a resistor device 5. The knob 4 has an open bottom and is equipped with a connector 41 extending in the direction of the open bottom. The housing 3 correspondingly has an aperture 30 through which the connector 41 passes. After passing through the aperture 30, the connector 41 is rotatably connected to the housing 3, allowing the knob 4 to rotate relative to the housing 3. The resistor device 5 is installed inside the housing 3 and is fixedly connected to the connector 41. In this way, the voltage inside the spray generation apparatus 10 can be adjusted from outside the device to meet different spray flow requirements, making the operation simple.

The housing 3 is provided with at least two different detent positions. When the knob 4 is rotated to the first detent position, the resistor device 5 outputs a first voltage value, and the spray generation apparatus 10 can spray liquid at a first pressure and flow rate. When the knob 4 is rotated to the second detent position, the resistor device 5 outputs a second voltage value, allowing the spray generation apparatus 10 to spray liquid at a second pressure and flow rate. The first voltage value is different from the second voltage value, resulting in different pressure and flow rates for the first and second positions. This configuration enables adjustment of the spray pressure and flow rate for a single nozzle to meet the demands of various operating conditions.

In this embodiment, five detent positions are provided, and corresponding numbers 1-5 are marked on the knob 4. The housing 3 is equipped with a position indicator line 34. When the knob 4 is rotated to the first detent position, the number 1 on the knob 4 aligns with the position indicator line 34, and accordingly, the resistor device 5 outputs the first voltage value, allowing the spray generation apparatus 10 to spray liquid at a first pressure and flow rate. When the knob 4 is rotated to the second detent position, the number 2 on the knob 4 aligns with the position indicator line 34, and accordingly, the resistor device 5 outputs the second voltage value, allowing the spray generation apparatus 10 to spray liquid at a second pressure and flow rate. This design allows users to conveniently select different detent positions based on the required pressure and flow rate of the sprayed liquid during use. Of course, in other embodiments, the number of detent positions can be adjusted as needed, with no specific limitation imposed.

The housing 3 is provided with a positioning seat 35 surrounding the aperture 30, and the positioning seat 35 is equipped with at least a first toothed groove 351 and a second toothed groove 352. The knob 4 also features a protruding portion 401 located on the side of the connector 41 and extending in the direction of the open bottom. When the protruding portion 401 is confined within the first toothed groove 351, the knob 4 is in the first detent position; when the protruding portion 401 is confined within the second toothed groove 352, the knob 4 is in the second detent position. In other words, when adjusting from the first detent position to the second detent position, the protruding portion 401 rotates from the first toothed groove 351 to the second toothed groove 352.

The first toothed groove 351 and the second toothed groove 352 are adjacent to each other, giving the outer edge of the positioning seat 35 a wavy shape. As a result, the tactile feedback provided by moving in and out of the wavy-shaped toothed grooves allows the user to adjust the detent positions without having to look at the position indicator. In this embodiment, five toothed grooves are provided: the first toothed groove 351, second toothed groove 352, third toothed groove 353, fourth toothed groove 354, and fifth toothed groove 355, corresponding to the five detent positions. Thus, when the protruding portion 401 switches between the five toothed grooves, five different liquid flow rates can be achieved. Of course, in other embodiments, the number of toothed grooves may vary, but there must be at least two to correspond to two different detent positions.

The control assembly 2 further includes an elastic member 40 fixedly connected to the knob 4. The elastic member 40 is sleeved on the connector 41, and the protruding portion 401 is disposed on the elastic member 40 and extends over the outside of the connector 41. As a result, when the knob 4 is switched between the first detent position and the second detent position, the protruding portion 401 is compressed, causing the elastic member 40 to deform. This allows the knob 4 to switch detent positions while rotating smoothly, utilizing the elasticity of the elastic member 40.

Specifically, the elastic member 40 includes a sleeved portion 403 that is sleeved on the outside of the connector 41 and a cantilevered portion 404 that is fixedly connected to the outer side wall of the sleeved portion 403. The protruding portion 401 is positioned at the middle of the cantilevered portion 404, and the sleeved portion 403 is fixedly connected to the connector 41. In the initial state, the protruding portion 401 is engaged in the first toothed groove 351. When the knob 4 is rotated, the connector 41 drives the sleeved portion 403 and the cantilevered portion 404 to rotate synchronously. The protruding portion 401 disengages from the first toothed groove 351 and gradually moves toward the second toothed groove 352. At this point, the protruding portion 401 is compressed, causing the cantilevered portion 404 to deform until the protruding portion 401 snaps into the second toothed groove 352. The cantilevered portion 404 then returns to its original shape under its own restoring force, successfully switching the knob 4 to the second detent position.

In this embodiment, the outer wall of the connector 41 is also provided with an integrally formed preformed block 43, and the sleeved portion 403 correspondingly has a preformed groove 402. When the elastic member 40 is fixedly connected to the knob 4, the preformed block 43 is housed in the preformed groove 402, allowing the sleeved portion 403 to remain relatively fixed with respect to the connector 41.

Of course, in other embodiments, the elastic member 40 may not be provided. In this case, the knob 4 can be configured with a double-layer structure that includes a base and a rotating member rotatably connected to the base. The base is fixedly connected to the housing 3, and the rotating member is positioned on the outside of the housing 3. The resistor device 5 is fixedly connected to the rotating member. When the rotating member is turned, the resistor device 5 can output different voltage values based on the degree of rotation of the rotating member. There are no limitations in this regard.

The bottom inner wall of the knob 4 is provided with an isolation post 42 that protrudes toward the connector 41. The housing 3 is further equipped with a first limiting part 321 and a second limiting part 322, both extending outwardly from the positioning seat 35. The first limiting part 321 and the second limiting part 322 extend in different directions, forming a limiting region 31 between them. When the knob 4 is connected to the housing 3, the isolation post 42 is located within the limiting region 31, and as the knob 4 rotates, the isolation post 42 slides along the limiting region 31. This design restricts the liquid pressure and flow rate within a fixed safety range, thereby preventing dangerous situations during use. Preferably, the limiting region 31 is a sector-shaped area of 200°, allowing the knob 4 to rotate between 0° and 200°. Of course, in other embodiments, the size of the limiting region 31 is not restricted, as long as it meets normal usage requirements.

In this embodiment, the first toothed groove 351 and the fifth toothed groove 355 are located at opposite ends of the limiting region 31. When only two toothed grooves are provided, the first toothed groove 351 and the second toothed groove 352 are positioned at opposite ends of the limiting region 31. Thus, when the isolation post 42 abuts against the first limiting part 321, the protruding portion 401 is housed in the second toothed groove, causing the spray liquid pressure and flow rate of the spray generation apparatus 10 to increase. When the isolation post 42 abuts against the second limiting part 322, the protruding portion 401 is housed in the first toothed groove 351, causing the spray liquid pressure and flow rate of the spray generation apparatus 10 to decrease.

The end of the connector 41 is provided with an elastically extending locking arm and a locking hook 44 protruding outwardly from the locking arm. The housing 3 includes a coupling portion 33 surrounding the aperture 30. When the knob 4 is connected to the housing 3, the locking hook 44 engages with the coupling portion 33. The design of the locking hook 44 and the coupling portion 33 not only allows the knob 4 to be rotatably mounted on the housing 3 but also ensures that the knob 4 does not easily detach from the housing 3 under external forces, thereby maintaining the stability of the connection between the knob 4 and the housing 3.

The resistor device 5 is provided with a positioning portion 52 and a positioning member 53 fixedly connected to the positioning portion 52. The positioning portion 52 is fixedly connected to the housing 3, and the positioning member 53 is provided with a positioning surface 531. A corresponding mating surface 410 is provided on the inner side wall of the connector 41. When the connector 41 passes through the aperture 30 and is fixedly connected to the resistor device 5, the positioning surface 531 and the mating surface 410 abut against each other, thereby fixing the resistor device 5 to the connector 41. This configuration allows the resistor device 5 to rotate synchronously with the knob 4.

In this embodiment, the positioning portion 52 is provided with a positioning hole 521, and the housing 3 is equipped with a corresponding positioning slot 37. The positioning hole 521 and the positioning slot 37 are aligned with each other so that a screw 51 can pass through the positioning hole 521 and the positioning slot 37, thereby achieving a fixed connection between the resistor device 5 and the housing 3.

One side of the outer wall of the positioning member 53 is an arc surface 532, while the other side is a flat surface, which serves as the positioning surface 531. The connector 41 is designed with a cavity (not numbered) that can accommodate the positioning member 53, and a stop post 411 is correspondingly arranged inside the cavity. The mating surface 410 is formed on the stop post 411, so when the positioning member 53 is inserted into the cavity of the connector 41, the positioning surface 531 of the positioning member 53 can abut against the mating surface 410 of the stop post 411. This configuration allows the positioning member 53 to rotate synchronously when the connector 41 rotates, thereby adjusting the voltage value. Of course, in other embodiments, other fixing methods may also be used, as long as the connector 41 can drive the positioning member 53 to rotate synchronously to adjust the voltage value of the resistor device 5.

In summary, the knob assembly 1 of the present application achieves its functionality by fixedly connecting the knob 4, which is arranged outside the housing 3, to the resistor device 5, which is located inside the housing 3, while also providing at least two different detent positions on the housing 3. As a result, rotating the knob 4 to different detent positions allows the resistor device 5 to output different voltage values. When applied to a spray generation apparatus 10 equipped with the knob assembly 1, rotating the knob 4 enables the control board inside the spray generation apparatus 10 to change the rotational speed of the water pump motor inside the spray generation apparatus 10, thereby adjusting the pressure and flow rate of the liquid being sprayed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A spray generation apparatus comprising:
a housing;
a knob, wherein the knob comprises an open bottom and a connector extending in a direction of the open bottom, wherein the housing comprises an aperture for the connector to pass through, wherein the connector is rotatably connected to the housing after passing through the aperture so that the knob is capable of rotating relative to the housing, wherein the housing comprises a first detent position and a second detent position, wherein the knob is capable of being rotated to the first detent position or the second detent position;
a resistor device, wherein the resistor device is disposed inside the housing, wherein the connector is attached to the resistor device;
a motor; and
a motor controller, for controlling the motor to generate a first spray with a first spray output pattern when the resistor device generates a first voltage value and the knob is at the first detent position, and to generate a second spray with a second spray output pattern when the resistor device generates a second voltage value and the knob is at the second detent position.

2. The spray generation apparatus of claim 1, wherein the housing comprises a positioning seat surrounding the aperture, the positioning seat being provided with at least a first toothed groove and a second toothed groove, and wherein the knob further comprises a protruding portion extending from a side of the connector in the direction of the open bottom, wherein the knob is in the first detent position when the protruding portion is confined within the first toothed groove, and the knob is in the second detent position when the protruding portion is confined within the second toothed groove.

3. The spray generation apparatus of claim 2, wherein the first toothed groove and the second toothed groove are adjacent to each other, such that the outer edge of the positioning seat has a wavy shape.

4. The spray generation apparatus of claim 2, wherein the control assembly further comprises an elastic member fixedly connected to the knob, wherein the elastic member is sleeved on the connector, wherein the protruding portion is disposed on the elastic member and extends over the outside of the connector, and wherein the protruding portion is compressed to deform the elastic member when the knob switches between the first detent position and the second detent position.

5. The spray generation apparatus of claim 2, wherein the bottom inner wall of the knob is provided with an isolation post protruding toward the connector, wherein the housing further comprises a first limiting part and a second limiting part extending outwardly from the positioning seat, the first limiting part and the second limiting part extending in different directions to form a limiting region between them, wherein when the knob is connected to the housing, the isolation post is located within the limiting region, and wherein when the knob is rotated, the isolation post slides along the limiting region.

6. The spray generation apparatus of claim 5, wherein the limiting region is a sector-shaped area of 200°, and wherein the knob is capable of rotating between 0° and 200°.

7. The spray generation apparatus of claim 5, wherein the first toothed groove and the second toothed groove are respectively located at opposite ends of the limiting region.

8. The spray generation apparatus of claim 1, wherein the end of the connector is provided with an elastically extending locking arm and a locking hook protruding outwardly from the locking arm, wherein the housing is provided with a coupling portion surrounding the aperture, and wherein when the knob is connected to the housing, the locking hook engages with the coupling portion.

9. The spray generation apparatus of claim 1, wherein the resistor device is provided with a positioning portion and a positioning member fixedly connected to the positioning portion, wherein the positioning portion is fixedly connected to the housing, and the positioning member is provided with a positioning surface, wherein a corresponding mating surface is provided on the inner side wall of the connector, and wherein when the connector passes through the aperture and is fixedly connected to the resistor device, the positioning surface and the mating surface abut against each other, thereby fixing the resistor device to the connector.

10. The spray generation apparatus of claim 1, further comprising a liquid tank, wherein the motor is controlled by the motor controller to generate the first spray with liquid stored in the liquid tank at a first pressure and flow rate, and wherein the motor is controlled by the motor controller to generate the second spray with liquid stored in the liquid tank.

11. The spray generation apparatus of claim 10, further comprising a battery container disposed in the housing, wherein a power switch is provided on the housing to turn on power.

12. The spray generation apparatus of claim 10, further comprising a second housing for disposing the motor and the liquid tank, wherein the second housing is separate from the housing.

13. The spray generation apparatus of claim 12, further comprising a bracket for placing the housing and the second housing.

14. The spray generation apparatus of claim 10, wherein different output patterns correspond to different watering patterns for gardening.

15. The spray generation apparatus of claim 14, wherein the liquid tank contains a pesticide mixer for mixing a pesticide with water for a required pesticide concentration.

16. The spray generation apparatus of claim 10, further comprising a movement device fixed to the housing, wherein the movement device automatically navigates an area for performing spray operation.

17. The spray generation apparatus of claim 10, further comprising a sensor to detect a liquid level in the liquid tank, wherein when the liquid level is below a threshold, a vibration message is generated to inform the user to refill the liquid tank.

18. The spray generation apparatus of claim 10, further comprising a lock on the housing, wherein when the lock is positioned at a lock position, the motor is disabled to prevent spraying danger spray in accident.

19. The spray generation apparatus of claim 10, wherein a spray pipe is detachably attached to the housing, wherein the s pray pipe is connected to spray exit of the housing.

20. The spray generation apparatus of claim 19, wherein a second knob is disposed on a distal end of the spray pipe away from the housing, wherein the second knob is operable to perform the same function as the knob to the motor controller.
